(19) United States
(12) Patent Application Publication
(10) Pub. No.: US 2023/0112976 A1
(43) Pub. Date: Apr. 13, 2023

(54) LENS DEVICE AND IMAGING APPARATUS

(71) Applicant: CANON KABUSHIKI KAISHA, Tokyo (JP)

(72) Inventor: Keiki Oikawa, Tochigi (JP)

(21) Appl. No.: 18/045,111

(22) Filed: Oct. 7, 2022

(30) Foreign Application Priority Data
Oct. 12, 2021 (JP) 2021-167601

(51) Int. Cl. G02B 7/10; G02B 7/02; G02B 13/00; G03B 17/14; H04N 5/225

(52) U.S. Cl. CPC G02B 7/10; G02B 7/021; G02B 13/001; G03B 17/14; H04N 5/2254

(57) ABSTRACT

A lens device includes a first moving member configured to hold an optical element and move in an optical axis direction, a first shaft member configured to engage with a first guide portion of the first moving member and configured to guide a movement of the first moving member in the optical axis direction, a base member configured to hold one end portion of the first shaft member, and a holding member configured to hold the other end portion of the first shaft member, wherein the base member is provided with an object side restriction end and an image side restriction end, the object side restriction end being configured to restrict the movement of the first moving member in a direction toward an object side, the image side restriction end being configured to restrict the movement of the first moving member in a direction toward an image side.

### BACKGROUND

### Field of the Disclosure

The present disclosure relates to a lens device and an imaging apparatus.

### Description of the Related Art

In recent years, to meet the demand for miniaturization of optical devices, such as a digital still camera and a digital video camera, miniaturization of lens devices attached to the optical devices is also required.

Among lens devices of optical apparatuses, such as a digital still camera and a digital video camera, some lens devices use two guide bars to move a member holding a lens for magnification and focusing of an optical system in the optical axis direction. Such a lens device has a structure in which the member holding the lens is engaged with the guide bars, and the lens is moved in the optical axis direction by an actuator.

Japanese Patent Application Laid-Open No. 2016-99523 discusses a lens barrel in which a first movable member holding a first lens group and a second movable member holding a second lens group are arranged in the optical axis direction and accommodated to be movable relative to a fixed frame. In the lens barrel discussed in Japanese Patent Application Laid-Open No. 2016-99523, an intermediate member is disposed as a collision prevention portion between the first and second movable members to prevent a collision between the first and second movable members.

However, in the lens barrel discussed in Japanese Patent Application Laid-Open No. 2016-99523, the intermediate member for preventing a collision between the first and second movable members may need additional space.

### SUMMARY

According to an aspect of the present disclosure, a lens device includes a first moving member configured to hold an optical element and move in an optical axis direction, a first shaft member configured to engage with a first guide portion of the first moving member and configured to guide a movement of the first moving member in the optical axis direction, a base member configured to hold one end portion of the first shaft member, and a holding member configured to hold the other end portion of the first shaft member, wherein the base member is provided with an object side restriction end and an image side restriction end, the object side restriction end being configured to restrict the movement of the first moving member in a direction toward an object side, the image side restriction end being configured to restrict the movement of the first moving member in a direction toward an image side.

Further features of the present disclosure will become apparent from the following description of exemplary embodiments with reference to the attached drawings.

### BRIEF DESCRIPTION OF THE DRAWINGS

FIGS. 1A to 1D are diagrams illustrating a rear group lens barrel according to a first exemplary embodiment.

FIG. 2 is a diagram illustrating configurations of a lens device and a camera main body.

FIG. 3 is a diagram illustrating cross-sectional views of the lens device in a wide state and a tele state.

FIG. 4 is a diagram illustrating an exploded perspective view of a rear group unit according to the first exemplary embodiment.

FIG. 5 is a diagram illustrating perspective views of the rear group unit according to the first exemplary embodiment.

FIG. 6 is a diagram illustrating plane views of a third group unit according to the first exemplary embodiment.

FIG. 7 is a diagram illustrating perspective views of a fifth group unit according to the first exemplary embodiment.

FIGS. 8A and 8B are diagrams illustrating assembly of the fifth group unit to the rear group lens barrel according to the first exemplary embodiment.

FIGS. 9A to 9E are diagrams illustrating the assembly of the fifth group unit to the rear group lens barrel according to the first exemplary embodiment.

FIG. 10 is a diagram illustrating assembly of a fourth group unit to the rear group lens barrel according to the first exemplary embodiment.

FIG. 11 is a diagram illustrating a cross-sectional view of the third group unit after assembly to the rear group lens barrel according to the first exemplary embodiment.

FIG. 12 is a diagram illustrating an exploded perspective view of a rear group unit according to a second exemplary embodiment.

FIG. 13 is a diagram illustrating a plane view and a cross-sectional view of a rear group lens barrel according to the second exemplary embodiment.

FIG. 14 is a diagram illustrating a front view and an exploded perspective view of a fifth group lens barrel according to the second exemplary embodiment.

FIGS. 15A to 15C are diagrams illustrating assembly of the fifth group lens barrel to the rear group lens barrel according to the second exemplary embodiment.

FIGS. 16A and 16B are diagrams illustrating an exploded perspective view and a front view illustrating a configuration of a third group unit with respect to a sixth group unit.

FIGS. 17A and 17B are diagrams illustrating placement of a flexible substrate extending from a diaphragm.

FIG. 18 is a diagram illustrating a sliding surface on which a leaf spring provided in a rear group lens barrel slides.

FIG. 19 is a diagram illustrating a direction of a biasing force of a leaf spring.

FIG. 20 is diagrams illustrating relationships between a biasing point of the biasing force of the leaf spring and engagement portions.

### DESCRIPTION OF THE EMBODIMENTS

Desirable exemplary embodiments of the present disclosure will be described in detail below based on the attached drawings. In the drawings, the same members are designated by the same reference numbers, and the redundant descriptions are omitted.

### Configuration of Lens Device

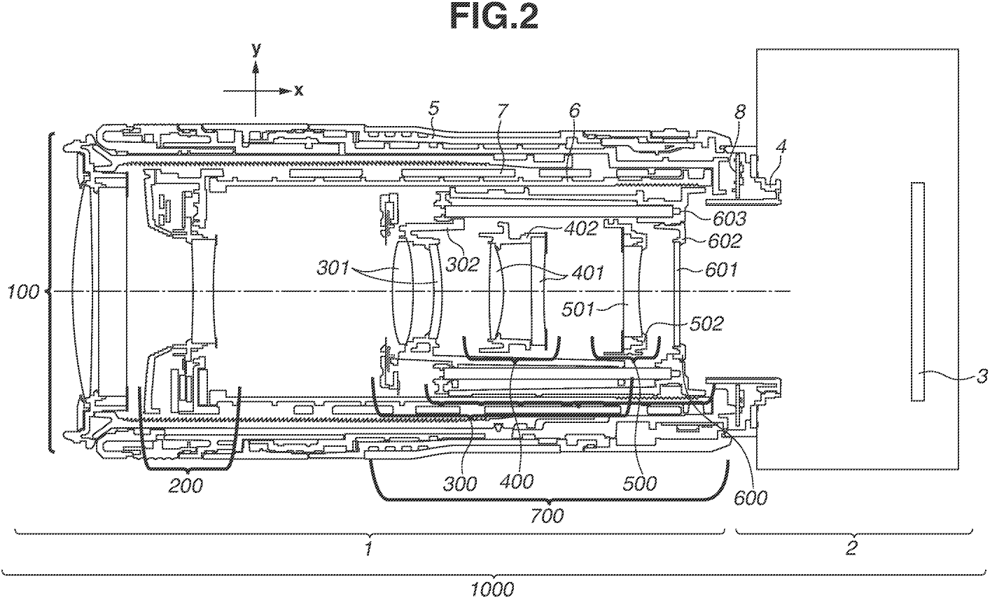

FIG. 2 is a schematic diagram illustrating an imaging apparatus 1000 in which a lens device 1 (a lens barrel) is attached to a camera 2 (a camera main body) according to a first exemplary embodiment of the present disclosure. The camera 2 includes an image sensor 3, such as a charge-coupled device (CCD) sensor or a complementary metal-oxide-semiconductor (CMOS) sensor, and can capture an image formed through the lens device 1. As described above, the imaging apparatus 1000 includes the image sensor 3 that receives light from the lens device 1.

The lens device 1 includes a mount 4 and is detachably attached to the camera 2 including a mount (not illustrated). The imaging apparatus 1000 according to the present disclosure is not limited to an imaging system, and examples of the imaging apparatus 1000 include an interchangeable lens camera and a lens-integrated camera. Examples of the camera 2 include imaging apparatuses, such as a digital still camera and a video camera.

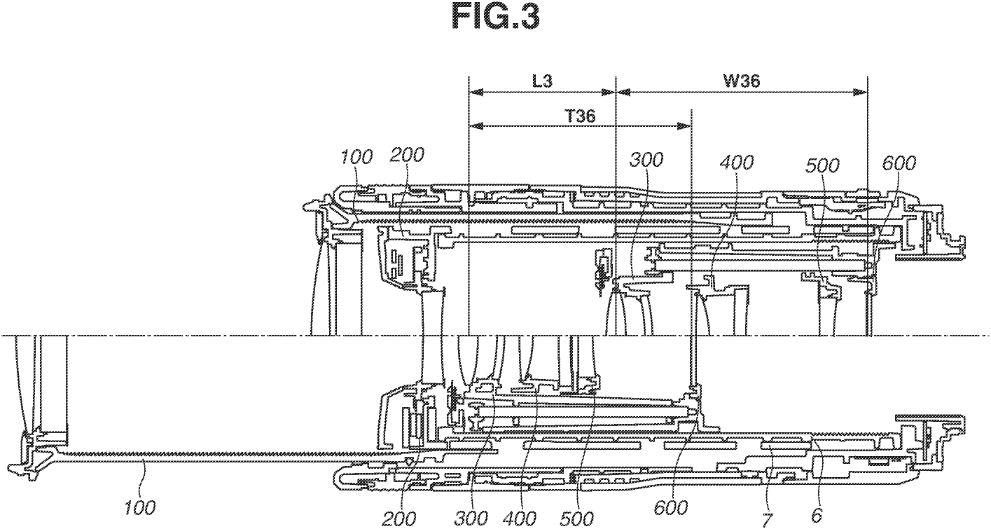

The upper part of FIG. 3 is a cross-sectional view illustrating positions of lens units in a wide state (on the wide-angle side) of the lens device 1. The lower part of FIG. 3 is a cross-sectional view illustrating positions of the lens units in a tele state (on the telephoto side) of the lens device 1.

The lens device 1 is a so-called zoom lens capable of changing the focal length by rotation of an operation ring 5. A cam barrel 7 (a cam ring) held to be rotatable outside a guide barrel 6 is linked to the operation ring 5, and the cam barrel 7 rotates according to the rotation of the operation ring 5. On the cam barrel 7, cam grooves (not illustrated) are provided. Further, on the guide barrel 6 (a straight movement barrel), straight movement grooves (not illustrated) parallel to the optical axis are provided.

The lens device 1 includes a first group unit 100, a second group unit 200, and a rear group unit 700 including a third group unit 300, a fourth group unit 400, a fifth group unit 500, and a sixth group unit 600, in order from the object side.

The first group unit 100 is engaged with a first group cam follower (not illustrated), the cam grooves, and the straight movement grooves. Thus, the position in the optical axis direction of the first group unit 100 changes according to the rotation of the operation ring 5.

In the present exemplary embodiment, a zooming operation from the wide state to the tele state greatly moves the first group unit 100 to the object side.

The second group unit 200 is fixed to an end on the object side of the guide barrel 6 using a second group cam follower (not illustrated). Unlike the first group unit 100, the second group unit 200 is not engaged with the cam grooves provided on the cam barrel 7, and thus, the position in the optical axis direction of the second group unit 200 does not change by a zoom operation. The second group unit 200 is an optical image stabilization unit. The second group unit 200 has a structure in which optical elements are moved in a direction orthogonal to the optical axis by a main central processing unit (CPU) 8 (a control unit) based on shake information regarding the lens device 1 obtained by a gyro sensor (not illustrated).

### Configuration of Rear Group 700

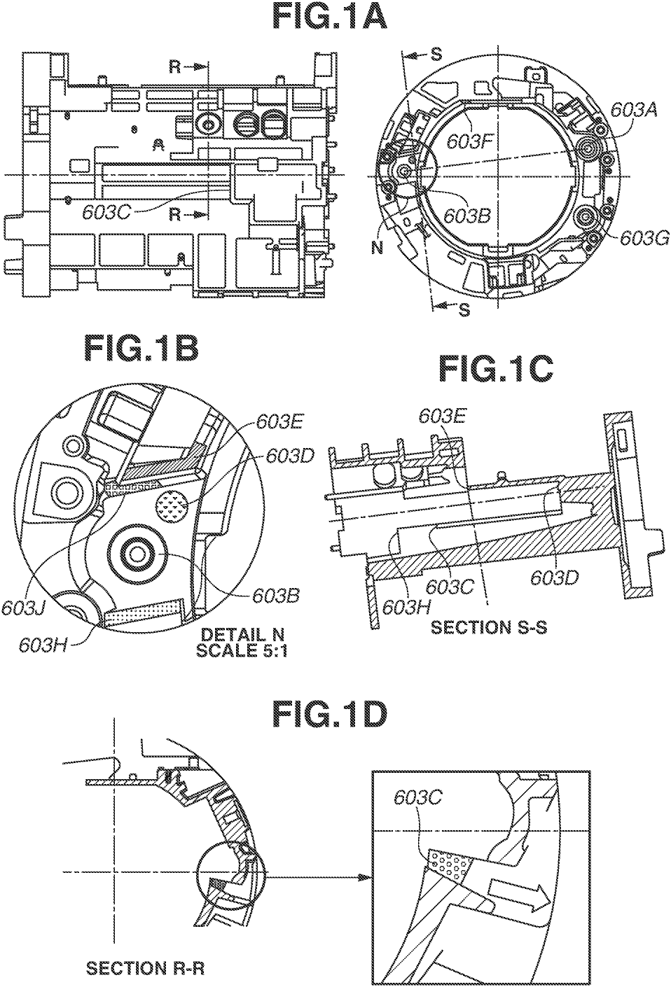

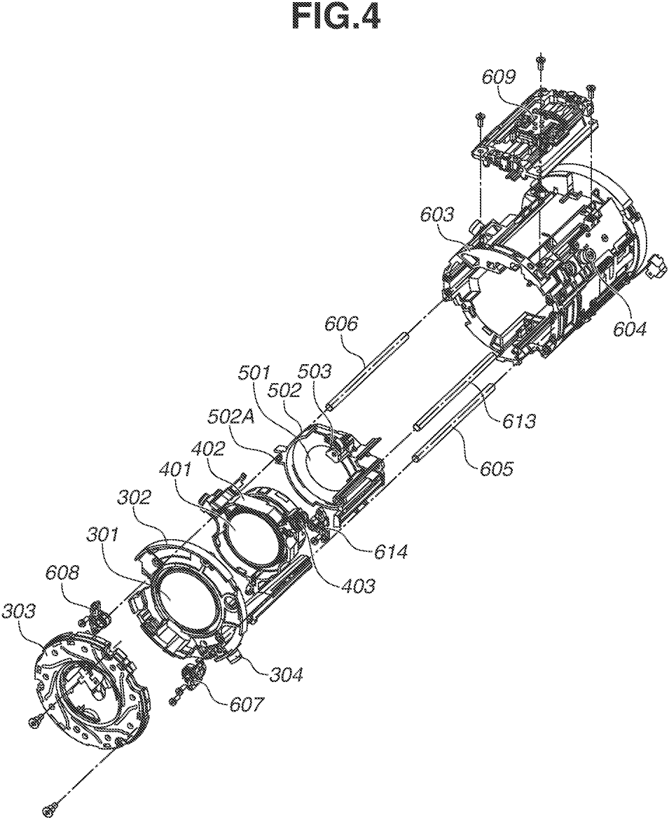

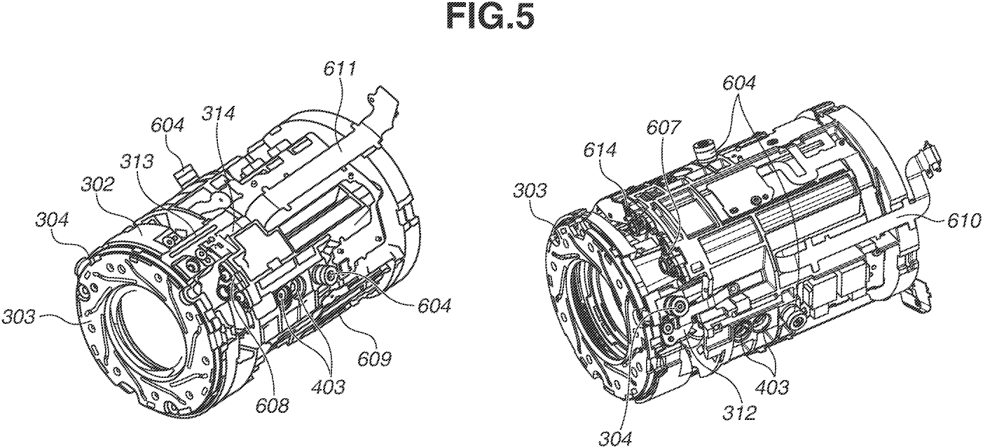

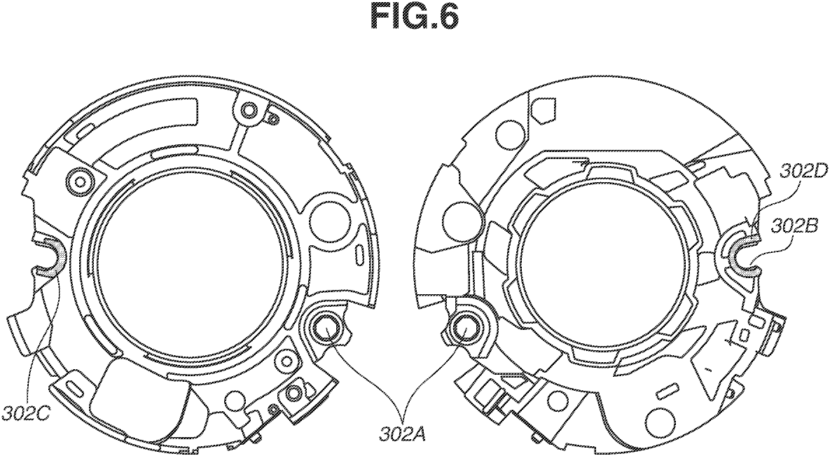

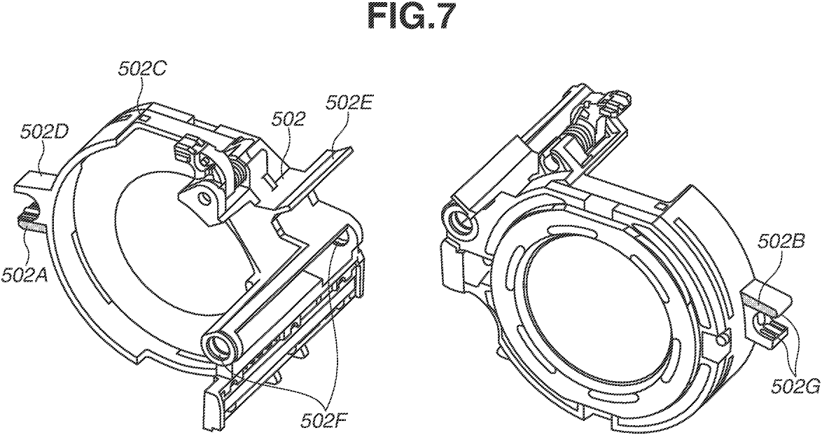

With reference to FIGS. 4 to 7, the rear group unit 700 is described. FIG. 4 is a diagram illustrating an exploded perspective view of the rear group unit 700 according to the present exemplary embodiment. FIG. 5 is a diagram illustrating perspective views of the rear group unit 700 according to the present exemplary embodiment. FIG. 6 is a diagram illustrating plane views of the third group unit 300 according to the present exemplary embodiment. The left diagram in FIG. 6 illustrates a third group lens barrel 302 viewed from the object side, and the right diagram in FIG. 6 illustrates the third group lens barrel 302 viewed from the image side. FIG. 7 is a diagram illustrating plane views of the fifth group unit 500 according to the present exemplary embodiment. FIGS. 1A to 1D are diagrams illustrating a rear group lens barrel 603 according to the present exemplary embodiment.

The rear group unit 700 is a unit in which the third group unit 300, the fourth group unit 400, the fifth group unit 500, and the sixth group unit 600 are held by a rear group lens barrel 603.

The third group unit 300 includes a third group lens barrel 302 holding third group lenses 301 and a diaphragm 303. The third group lens barrel 302 includes a third group cam follower 304 serving as a driving unit for driving the third group unit 300 in the optical axis direction, and the third group cam follower 304 is engaged with one of the cam grooves of the cam barrel 7.

The third group lens barrel 302 is engaged with a first guide shaft 605 by a third group straight movement guide portion 302A of the third group lens barrel 302. One end portion of the first guide shaft 605 is held by a shaft holding portion 603G (FIG. 1A) provided in the rear group lens barrel 603, and the other end portion of the first guide shaft 605 is held by a first shaft holding member 607. The first shaft holding member 607 is fixed with a screw to the rear group lens barrel 603, whereby the third group unit 300 is guided in the optical axis direction relative to the rear group lens barrel 603.

In the third group lens barrel 302, a third group shake prevention portion 302B is engaged with a second guide shaft 606. One end portion of the second guide shaft 606 is held by a shaft holding portion 603B (FIG. 1A) provided in the rear group lens barrel 603, and the other end portion of the second guide shaft 606 is held by a second shaft holding member 608. The second shaft holding member 608 is fixed with a screw to the rear group lens barrel 603. Consequently, the third group straight movement guide portion 302A and the third group shake prevention portion 302B are engaged with the first guide shaft 605 and the second guide shaft 606, respectively, and the third group lens barrel 302 is guided in the optical axis direction relative to the rear group lens barrel 603 without rotating about the optical axis.

In this configuration, the position of the third group lens barrel 302 in the optical axis direction is determined by the engagement of a single follower, i.e., the third group cam follower 304, held by the third group lens barrel 302 with one of the cam grooves of the cam barrel 7. The third group unit 300 includes a third group object side restriction end 302C and a third group image side restriction end 302D for reducing damage to components near the third group unit 300 or damage to the third group unit 300 itself due to an excessive deformation or movement of the third group unit 300 which can be caused by an impact applied to the lens device 1.

Next, the fourth group unit 400 is described. The fourth group unit 400 includes a fourth group lens barrel 402 holding fourth group lenses 401. In the fourth group unit 400, six fourth group cam followers 403 for holding the fourth group unit 400 inside the rear group lens barrel 603 are held by the fourth group lens barrel 402 and engaged with the rear group lens barrel 603. Although the details are not described because this is a known technique, the fourth group unit 400 has such a structure that the fourth group unit 400 is tilted relative to the rear group lens barrel 603 by the fourth group cam followers 403 to perform eccentricity adjustment.

Next, the fifth group unit 500 is described. The fifth group unit 500 is a so-called focus group. The fifth group unit 500 includes a fifth group lens 501 and a fifth group lens barrel 502 holding a linking member 503 to which a driving force of an actuator 609 is transmitted. In the fifth group lens barrel 502, a fifth group straight movement guide portion 502F of the fifth group lens barrel 502 is engaged with a third guide shaft 613. One end portion of the third guide shaft 613 is held by a shaft holding portion 603A (FIG. 1A) provided in the rear group lens barrel 603, and the other end portion of the third guide shaft 613 is held by a third shaft holding member 614. The third shaft holding member 614 is fixed with a screw to the rear group lens barrel 603. Consequently, the fifth group unit 500 is guided in the optical axis direction relative to the rear group lens barrel 603. In the fifth group lens barrel 502, a fifth group shake prevention portion 502G is engaged with the second guide shaft 606.

In the above-described configuration, the fifth group straight movement guide portion 502F and the fifth group shake prevention portion 502G are engaged with the third guide shaft 613 and the second guide shaft 606, respectively, and thus the fifth group lens barrel 502 is guided in the optical axis direction inside the rear group lens barrel 603 without rotating in a plane orthogonal to the optical axis. As described above, since the third group shake prevention portion 302B is also engaged with the second guide shaft 606, the second guide shaft 606 is shared by the fifth group lens barrel 502 and the third group lens barrel 302. This reduces the number of components.

The actuator 609 for driving the fifth group unit 500 in the optical axis direction is held by the rear group lens barrel 603 and linked to the fifth group lens barrel 502 by the linking member 503.

The actuator 609 is connected to a flexible substrate 611 and connected to the main CPU 8. The main CPU 8 detects the position of the fifth group unit 500 in the optical axis direction using a position sensor (not illustrated) mounted on a flexible substrate 610. Based on position information obtained from the position sensor and a command from the camera 2, the main CPU 8 issues a driving command to the actuator 609. Examples of the actuator 609 include a friction drive actuator utilizing a combination of vibration and friction, and an electromagnetic actuator using a magnet and a coil, and the like.

The sixth group unit 600 includes a sixth group lens barrel 602 holding a sixth group lens 601 and is fixed to the mount side of the rear group lens barrel 603 (the image side of the lens device 1).

Next, a movement of the whole of the rear group unit 700 in the optical axis direction is described. In the rear group unit 700, three rear group cam followers 604 are held by the rear group lens barrel 603 and engaged with the cam grooves on the cam barrel 7 and the straight movement grooves on the guide barrel 6. That is, similarly to the first group unit 100, the position in the optical axis direction of the rear group unit 700 is changed by the cam barrel 7 rotating in conjunction with the rotation of the operation ring 5. As described above, in the third group unit 300, the third group cam follower 304 held by the third group lens barrel 302 is engaged with one of the cam grooves having a trajectory different from those of the rear group cam followers 604, and thus, the third group cam follower 304 moves along a trajectory different from the rear group lens barrel 603 in the zoom operation.

### Assembly of Rear Group 700

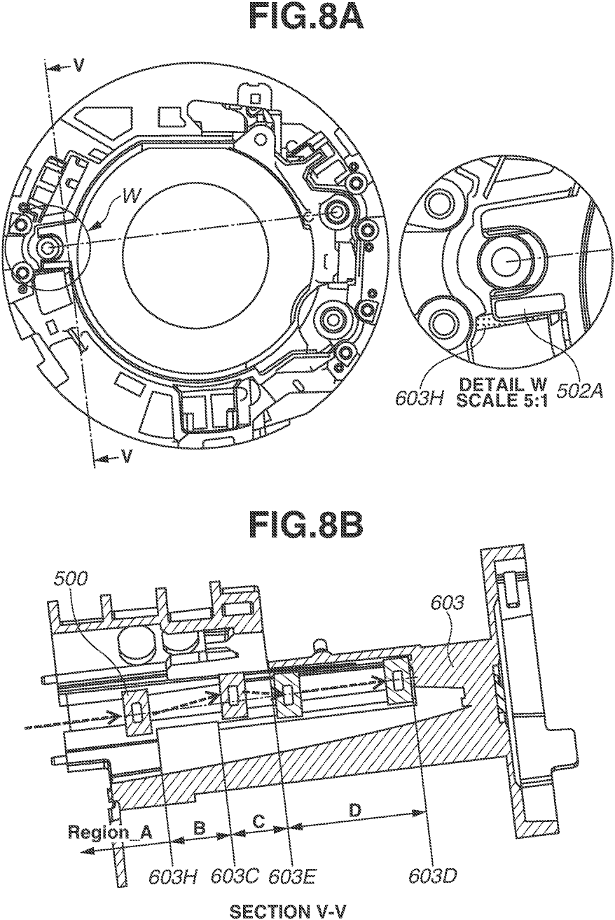

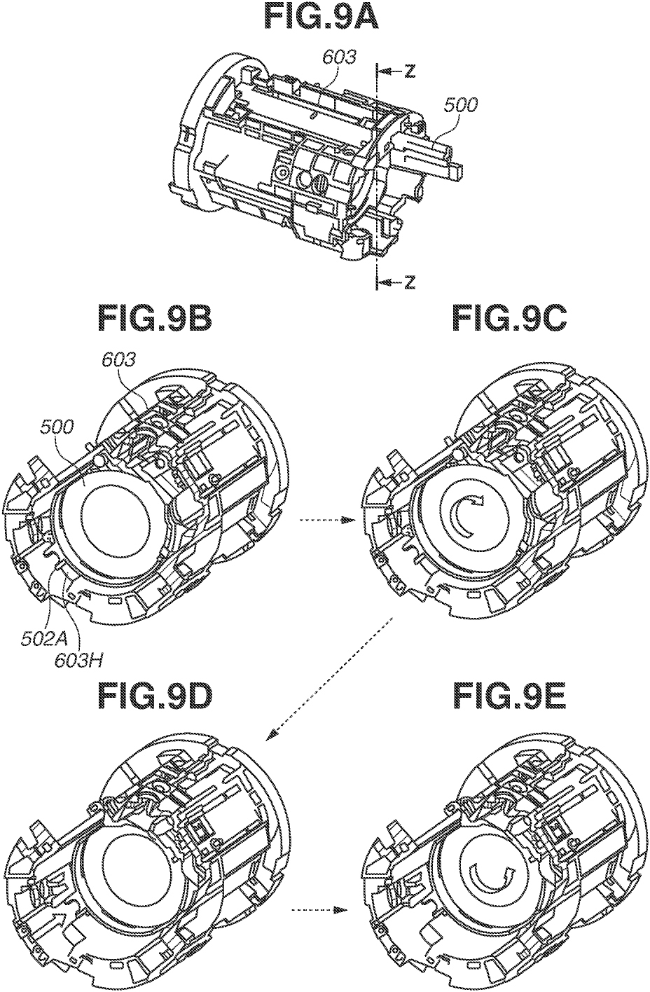

Next, with reference to FIGS. 1A to 1D, FIGS. 8A and 8B, and FIGS. 9A to 9E, the assembly of the rear group unit 700 according to the present exemplary embodiment is described. FIGS. 1A to 1D are diagrams illustrating the rear group lens barrel 603 according to the present exemplary embodiment. FIGS. 8A and 8B and FIGS. 9A to 9E are diagrams illustrating the assembly of the fifth group unit 500 to the rear group lens barrel 603 according to the present exemplary embodiment. FIGS. 9A to 9E are diagrams complementing the description of FIGS. 8A and 8B.

FIG. 1A is a front view and a side view of the rear group lens barrel 603. FIG. 1B is an enlarged view of the periphery of the shaft holding portion 603B. FIG. 1C is a cross-sectional view of the rear group lens barrel 603 when viewed from inside.

The rear group lens barrel 603 includes a first rotation restriction portion 603F and a second rotation restriction portion 603J that are used when the fifth group unit 500 is incorporated into the rear group lens barrel 603, and an insertion restriction end 603E that restricts the movement of the fifth group unit 500 in an insertion direction of the fifth group unit 500. A description of how to use the first rotation restriction portion 603F and the second rotation restriction portion 603J in assembly will be provided below.

The rear group lens barrel 603 includes an object side restriction end 603C that restricts the movement of the fifth group unit 500 to the object side in the optical axis direction, and an image side restriction end 603D that restricts the movement of the fifth group unit 500 to the image side in the optical axis direction. On the object side of the object side restriction end 603C, the rear group lens barrel 603 includes a third group object side restriction end 603H that restricts the movement of the third group unit 300 to the image side in the optical axis direction.

The object side restriction end 603C comes into contact with an object side moving member restriction end 502A provided in the fifth group lens barrel 502. The image side restriction end 603D comes into contact with an image side moving member restriction end 502B provided in the fifth group lens barrel 502. The two restriction ends (502A and 502B) function to reduce collision damage to the fourth group unit 400 or the sixth group unit 600 adjacent to the fifth group unit 500 or reduce damage to the fifth group unit 500 itself due to, for example, excessive movement of the fifth group unit 500 which can be caused by an impact applied to the lens device 1.

FIG. 1D is a cross-sectional view of the object side restriction end 603C when viewed from the image side of the lens device 1. The rear group lens barrel 603 is formed of resin-molded components, and among the molded components is the rear group lens barrel 603 that is formed using a mold having an external slide core that moves in the direction of an arrow illustrated in FIG. 1D. Consequently, a restriction end that restricts the movement of the fifth group unit 500 to the object side and the image side can be formed of a single component of the rear group lens barrel 603 without providing an additional component.

Next, a procedure for incorporating the fifth group unit 500 into the rear group lens barrel 603 is described. FIG. 8A is a front view of the rear group lens barrel 603 and the fifth group unit 500 when viewed from front.

In the present exemplary embodiment, the object side restriction end 603C and the object side moving member restriction end 502A are provided below a straight line connecting the shaft centers of the second guide shaft 606 and the third guide shaft 613 on the plane of the paper.

When the lens device 1 (the rear group unit 700) is viewed in the optical axis direction (viewed from the image side), at least a part of the object side restriction end 603C overlaps the object side moving member restriction end 502A.

However, in the present disclosure, since a restriction ends that restrict the movement of the fifth group unit 500 to the object side and the image side are formed of a single component of the rear group lens barrel 603, the third group object side restriction end 603H hinders insertion of the fifth group unit 500 when the fifth group unit 500 is incorporated into the rear group lens barrel 603.

Thus the following procedure is performed to incorporate the fifth group unit 500 into the rear group lens barrel 603. FIG. 8B is a diagram illustrating the movement trajectory of the fifth group unit 500 of when the fifth group unit 500 is incorporated into the rear group lens barrel 603. The movement trajectory of the fifth group unit 500 of when the fifth group unit 500 is incorporated is also illustrated in cross-sectional views in FIGS. 9B to 9E along a cross section Z-Z in FIG. 9A.

An area on the object side with respect to the third group object side restriction end 603H is a region A, an area between the third group object side restriction end 603H and the object side restriction end 603C is a region B, an area between the object side restriction end 603C and the insertion restriction end 603E is a region C, and an area between the insertion restriction end 603E and the image side restriction end 603D is a region D.

The region A is an area where the insertion of the fifth group unit 500 into the rear group lens barrel 603 is started (FIG. 9B). The third group object side restriction end 603H and the object side moving member restriction end 502A partly overlap each other when viewed in the optical axis direction. In this state, since the third group object side restriction end 603H interferes with the fifth group unit 500, it is difficult to insert the fifth group unit 500. Thus, to insert the fifth group unit 500 from the region A to the region B, the fifth group unit 500 is rotated about any rotational axis approximately parallel to the optical axis, as illustrated in FIG. 9C. The fifth group unit 500 avoids an interference with the third group object side restriction end 603H by the rotation and is allowed to pass through the region B. In the present exemplary embodiment, the fifth group unit 500 is rotated in the state where the third guide shaft 613 approximately parallel to the optical axis is inserted. That is, the fifth group unit 500 is rotated about the third guide shaft 613 as the rotational axis. The rotatable amount of the fifth group unit 500 in this process is A.

After the fifth group unit 500 passes through the region B, the fifth group unit 500 continues to be inserted in the region C, and then the fifth group unit 500 interferes with the insertion restriction end 603E (FIG. 9D). In this process, as illustrated in FIG. 9E, the fifth group unit 500 is rotated in a direction opposite to the rotation illustrated in FIG. 9C, to avoid the interference with the insertion restriction end 603E. The rotatable amount of the fifth group unit 500 in this process is B. The rotatable amount A of the fifth group unit 500 in the region C is greater than the rotatable amount B of the fifth group unit 500 in the region D. Then, the fifth group unit 500 is inserted from the region C to the region D, and the process of inserting the fifth group unit 500 into the rear group lens barrel 603 ends.

In the regions A, B, and C, it is possible to prevent the excessive rotation of the fifth group unit 500. For example, the first rotation restriction portion 603F and a moving member first rotation restriction end 502C come into contact with each other to avoid deformation of or damage to a position detection sensor fin 502E and other shapes, such as a photointerrupter (not illustrated) mounted on the flexible substrate 610 due to a contact with the rear group lens barrel 603. In the region D, because a moving member second rotation restriction end 502D comes into contact with the second rotation restriction portion 603J, an excessive rotation of the fifth group unit 500 is prevented. As described above, a rotation restriction portion is provided to prevent an unexpected failure of when the fifth group unit 500 is inserted.

The rotatable amount of the fifth group unit 500 in the region D is smaller than the rotatable amounts of the fifth group unit 500 in the regions A, B, and C. This prevents or reduces a shift between the shaft holding portion 603B of the rear group lens barrel 603 and the fifth group shake prevention portion 502G, which further prevents or reduces the amount of shift when the second guide shaft 606 is inserted into the shaft holding portion 603B. Thus, an insertion of the second guide shaft 606 in the region D becomes easier.

The third guide shaft 613 can be inserted after the fifth group unit 500 is inserted, or the fifth group unit 500 can be inserted after the third guide shaft 613 is inserted.

After the fifth group unit 500, the second guide shaft 606, and the third guide shaft 613 are inserted into the rear group lens barrel 603, the third shaft holding member 614 is fixed with a screw to the rear group lens barrel 603. Since the second guide shaft 606 is shared by the third group unit 300 and the fifth group unit 500, the second shaft holding member 608 is not fixed to the rear group lens barrel 603 in this process.

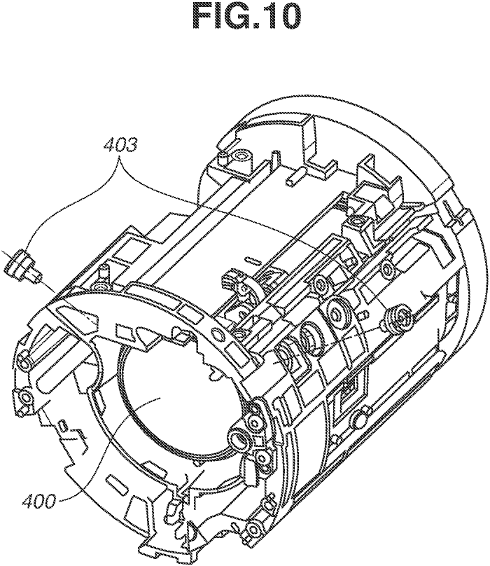

Next, a procedure for incorporation of the fourth group unit 400 into the rear group lens barrel 603 is described. FIG. 10 is a diagram illustrating assembly of the fourth group unit 400. The fourth group unit 400 is inserted into the rear group lens barrel 603 to which the fifth group unit 500 is assembled as described above. As described above, the fourth group unit 400 is configured to be held by the rear group lens barrel 603 using the six fourth group cam followers 403. After the fourth group unit 400 is inserted into the rear group lens barrel 603, the fourth group unit 400 is fixed by fixing the fourth group cam followers 403 with screws from radial directions.

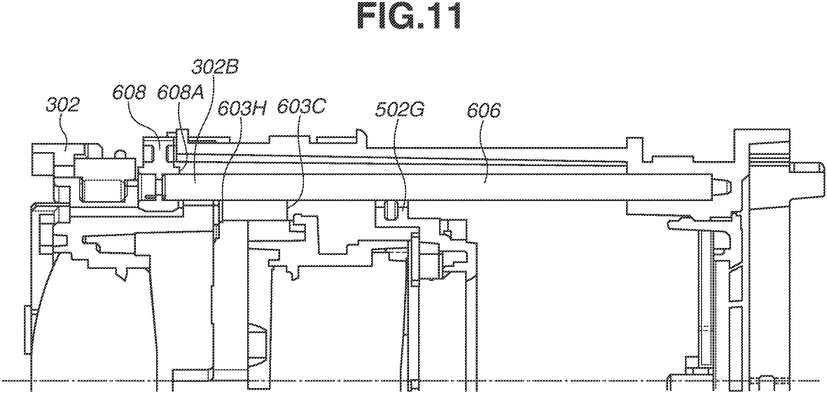

Next, a procedure for incorporation of the third group unit 300 into the rear group lens barrel 603 is described. FIG. 11 is a cross-sectional view of the state after the third group unit 300 is assembled to the rear group lens barrel 603. FIG. 11 illustrates a cross-sectional view taken along the optical axis and the shaft center of the second guide shaft 606.

After the fourth group unit 400 is incorporated into the rear group lens barrel 603, the second guide shaft 606 is inserted. In this process, while the second guide shaft 606 is engaged with the fifth group shake prevention portion 502G, one end portion of the second guide shaft 606 is held by the shaft holding portion 603B of the rear group lens barrel 603.

Next, the third group unit 300 is inserted into the rear group lens barrel 603. As described above, the third group straight movement guide portion 302A of the third group lens barrel 302 is engaged with the first guide shaft 605. The third group unit 300 can be inserted after the first guide shaft 605 is held by the rear group lens barrel 603, or can be inserted while the first guide shaft 605 is engaged with the third group straight movement guide portion 302A. The third group shake prevention portion 302B is engaged with the second guide shaft 606 when the third group unit 300 is inserted. As described above, the second guide shaft 606 is shared by the third group shake prevention portion 302B of the third group unit 300 and the fifth group shake prevention portion 502G of the fifth group unit 500. After the third group unit 300 is inserted, one end portion of the second guide shaft 606 is held by the second shaft holding member 608, and the second guide shaft 606 is fixed with a screw to the rear group lens barrel 603.

As described above, in the third group unit 300, the third group object side restriction end 302C and the third group image side restriction end 302D are provided. The third group object side restriction end 302C can come into contact with a third group movement restriction end 608A provided in the second shaft holding member 608. The third group image side restriction end 302D can come into contact with the third group object side restriction end 603H. The restriction ends reduce damage to components near the third group unit 300 or damage to the third group unit 300 itself due to an excessive deformation or movement of the third group unit 300 which can be caused by an impact applied to the lens barrel.

Finally, although the details are omitted, the diaphragm 303 is fixed with screws to the third group lens barrel 302, and a diaphragm flexible substrate 314 is linked to a connector portion of the flexible substrate 611, whereby the assembly of the rear group unit 700 ends.

In the present exemplary embodiment, a description has been given of a form in which the third group lens barrel 302 moves along the guide shafts. Alternatively, the third group lens barrel 302 can be fixed to the guide shafts. A different lens barrel holding another optical element can further be engaged with the guide shafts.

As described above, it is possible to provide the restriction ends on the object side and the image side of the fifth group unit 500 without an additional component in the rear group lens barrel 603. Thus, spaces for additional components for restriction ends and spaces for screws for fixing the additional components are unnecessary. This leads to miniaturization of the lens device 1.

### Configuration of Rear Group 7000

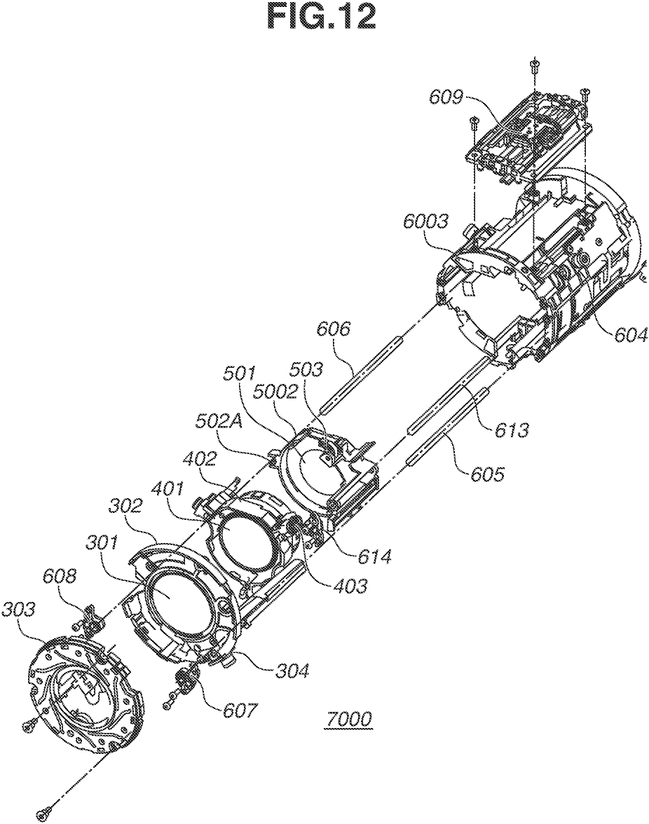

Next, a desirable exemplary embodiment according to a second exemplary embodiment of the present disclosure is described in detail based on the attached drawings. Contents similar to those of the first exemplary embodiment are not described, and the differences from the first exemplary embodiment are mainly described. The second exemplary embodiment is different from the first exemplary embodiment in the shapes of a rear group lens barrel 6003 and a fifth group lens barrel 5002. A description for a holding method is omitted. With reference to FIG. 12 to FIGS. 15A to 15C, a rear group unit 7000 is described. FIG. 12 is an exploded perspective view of the rear group unit 7000 according to the second exemplary embodiment.

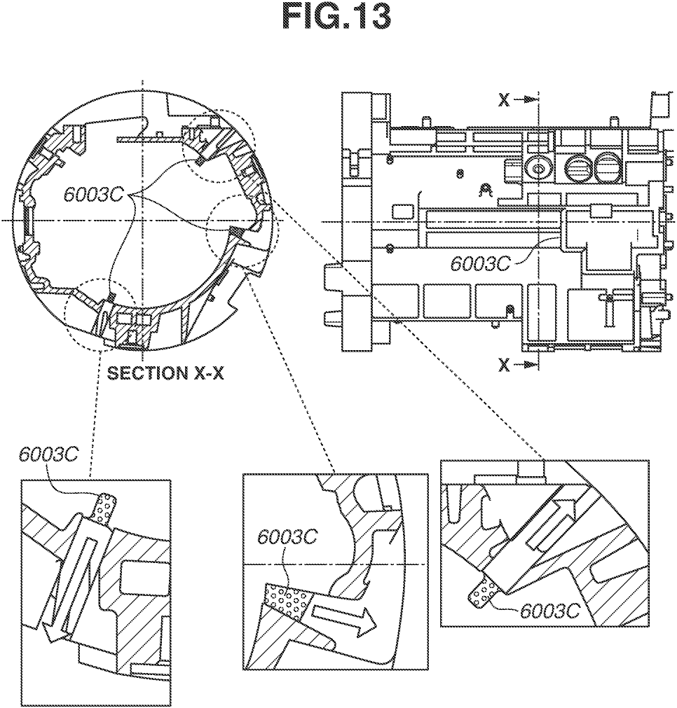

FIG. 13 is a cross-sectional view and enlarged views of a rear group lens barrel 6003 according to the second exemplary embodiment. In the second exemplary embodiment, unlike the first exemplary embodiment, three object side restriction ends 6003C are provided. Each of the object side restriction ends 6003C is formed using a mold having an external slide core that moves in a direction of an arrow illustrated in FIG. 13.

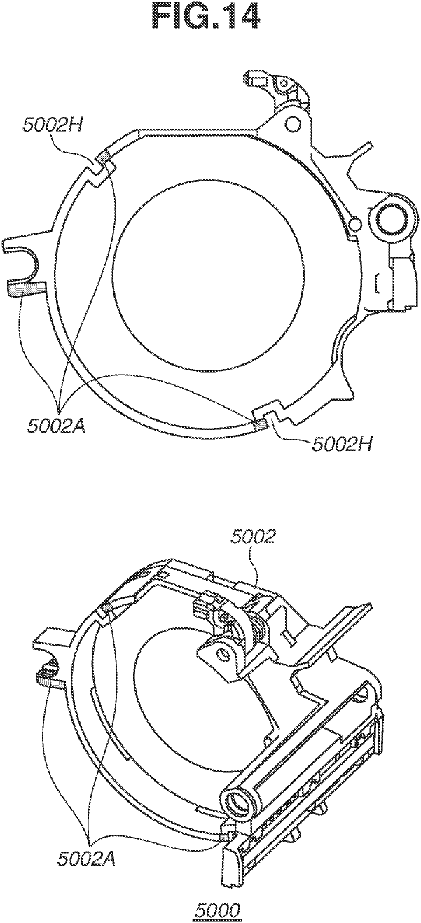

FIG. 14 is a perspective view and a front view of a fifth group unit 5000 according to the second exemplary embodiment. The shape of a fifth group lens barrel 5002 is different from the shape of the fifth group lens barrel 502 according to the first exemplary embodiment. Specifically, in the fifth group lens barrel 5002, object side moving member restriction ends 5002A are each provided to corresponding one of the three object side restriction ends 6003C provided in the rear group lens barrel 6003. In the fifth group lens barrel 5002, insertion grooves 5002H for avoiding the object side restriction ends 6003C when the fifth group unit 5000 is incorporated into the rear group lens barrel 6003 are provided.

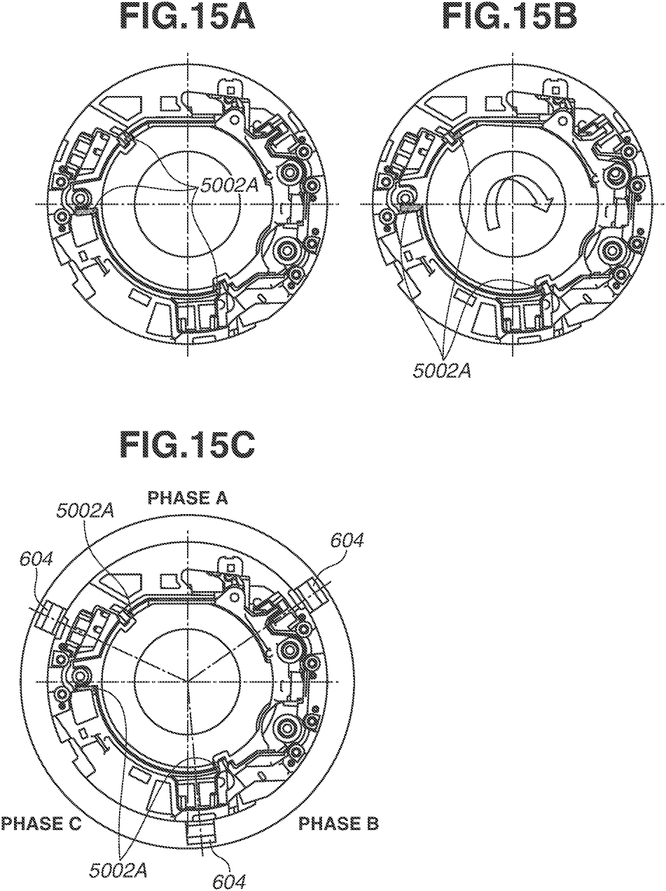

FIGS. 15A to 15C are diagrams illustrating the assembly of the fifth group lens barrel 5002 to the rear group lens barrel 6003 according to the second exemplary embodiment.

FIG. 15A illustrates an area where insertion of the fifth group unit 5000 into the rear group lens barrel 6003 is started, and corresponds to the region A illustrated in FIG. 8B. At least the object side restriction ends 6003C and the object side moving member restriction ends 5002A partly overlap each other when viewed in the optical axis direction. When the fifth group unit 5000 is inserted from the region A to the region B, the object side restriction ends 6003C interfere with the fifth group unit 5000, which makes it difficult to insert the fifth group unit 5000.

Thus, as illustrated in FIG. 15B, the fifth group unit 5000 is rotated about any rotational axis approximately parallel to the optical axis. Due to the rotation, the fifth group unit 5000 avoids interference with the shapes of the object side restriction ends 6003C, and the fifth group unit 5000 passes through the region B. In the second exemplary embodiment, two of the object side restriction ends 6003C pass through the insertion grooves 5002H provided in the fifth group lens barrel 5002, and thus, the fifth group unit 5000 can smoothly pass through the region B without interference. After the fifth group unit 5000 passes through the region B, the fifth group unit 5000 is rotated in a direction opposite to the direction illustrated in FIG. 15B. Due to the opposite direction rotation, it is possible to insert the fifth group unit 5000 to the region D, similarly to the first exemplary embodiment.

FIG. 15C illustrates the relationships between the rear group cam followers 604 and the object side moving member restriction ends 5002A (the object side restriction ends 6003C). As illustrated in FIG. 15C, phase areas between the three rear group cam followers 604 are defined as a phase A, a phase B, and a phase C, each of the object side restriction ends 6003C is provided in a different one of the phases A, B, and C. Although the object side restriction end 603C is provided only in the phase area corresponding to the phase C in the first exemplary embodiment, object side restriction ends can also be provided in the phase areas corresponding to the phases A and B as illustrated in the second exemplary embodiment.

### Other Configurations

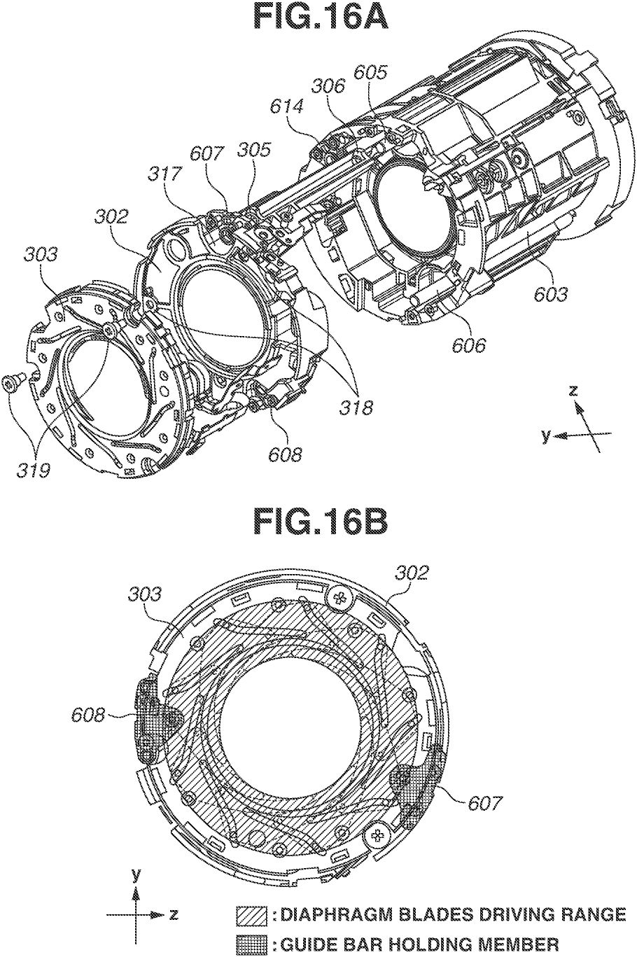

Other configurations of the first and second exemplary embodiments are described. FIGS. 16A and 16B are an exploded perspective view and a front view illustrating the configuration of the third group unit 300 with respect to the sixth group unit 600.

In the sixth group unit 600, one end portion of each of the second guide shaft 606 and the third guide shaft 613 is fixed to the rear group lens barrel 603. In the fifth group unit 500 is inserted while being engaged with the second guide shaft 606 and the third guide shaft 613. Then, the fourth group unit 400 is connected and fixed to the inner circumference of the rear group lens barrel 603 using the fourth group cam followers 403. In this state, the other end portion of the third guide shaft 613 is fixedly held by the rear group lens barrel 603, by the third shaft holding member 614. Further, the first guide shaft 605 is inserted into the rear group lens barrel 603, and one end portion of the first guide shaft 605 is fixed.

A first engagement portion 305 and a second engagement portion 306 that are formed in the third group lens barrel 302 holding the third group lenses 301 are linked to a wall portion 317 extending in the optical axis direction and disposed on the image side in the optical axis direction. Similarly, a first abutment surface is also linked to the wall portion 317 extending in the optical axis direction and disposed on the image side in the optical axis direction. In this state, the wall portion 317 is at a position where the wall portion 317 passes on the inner circumference side with respect to the first guide shaft 605 and the second guide shaft 606. The third group lens barrel 302 is inserted while being engaged with the first guide shaft 605 and the second guide shaft 606. The other end portions of the first guide shaft 605 and the second guide shaft 606 are fixed to the rear group lens barrel 603 by the first shaft holding member 607 and the second shaft holding member 608, respectively.

In the third group lens barrel 302, diaphragm holding portions 318 are provided to integrally hold the diaphragm 303. The diaphragm holding portions 318 are fixedly held with screws 319 so that the diaphragm 303 abuts the diaphragm holding portions 318. In this state, as illustrated in FIGS. 16A and 16B, the diaphragm 303, the first shaft holding member 607 (the second shaft holding member 608), and the first engagement portion 305 (the first abutment surface) are arranged in this order along the optical axis direction.

FIG. 16B is a front view illustrating the placement of the third group unit 300, the first shaft holding member 607, and the second shaft holding member 608. The diaphragm 303 is a structure where a plurality of blade members is driven to adjust the amount of light. A diaphragm blades driving range illustrated in FIG. 16B is an area required for the amount-of-light adjustment function. As illustrated in the areas of guide bar holding members in FIG. 16B, the first shaft holding member 607 and the second shaft holding member 608 overlap the diaphragm blades driving range in a plane orthogonal to the optical axis.

The first shaft holding member 607 (the second shaft holding member 608) is disposed between the diaphragm 303 and the first engagement portion 305 (the first abutment surface) of the third group lens barrel 302 provided on the image side with respect to the diaphragm 303 in the optical axis direction. Consequently, it is possible to dispose the first shaft holding member 607 and the second shaft holding member 608 in a function range (the diaphragm blades driving range) without impeding the function of the diaphragm 303 in a direction orthogonal to the optical axis. With these components, it is possible to miniaturize the placement of the first guide shaft 605 and the second guide shaft 606 in the radial direction. This leads to miniaturization of the rear group lens barrel 603, and further leads to miniaturization of the lens device 1.

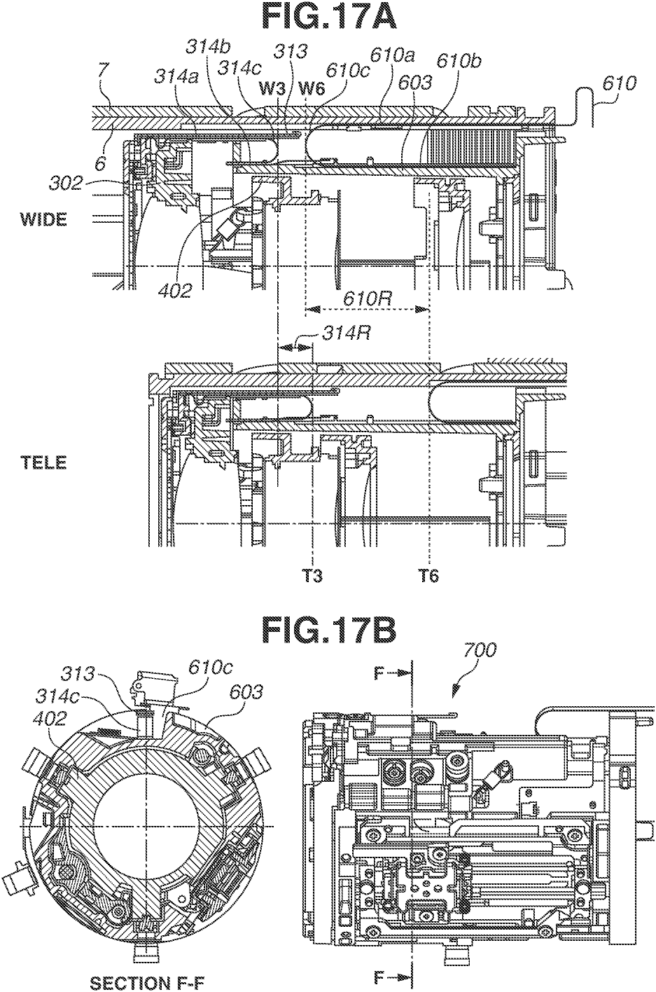

As illustrated in FIGS. 17A and 17B, in the diaphragm flexible substrate 314 extending from the diaphragm 303, a diaphragm flexible substrate fixing portion 314a is held by a diaphragm flexible substrate holding member 313, and a diaphragm flexible substrate fixing portion 314b is fixed to the rear group lens barrel 603. Between the diaphragm flexible substrate fixing portions 314a and 314b, a position absorption portion 314c having a protruding curved shape (a U-turn shape) that absorbs a change in a relative position between the third group lens barrel 302 and the rear group lens barrel 603 in the optical axis direction is formed.

The diaphragm flexible substrate 314 is connected to the flexible substrate 610 and connected to the main CPU 8 as described below. In the present exemplary embodiment, a zoom operation from the wide state to the tele state moves the position absorption portion 314c to a side of the mount 4 relative to the rear group lens barrel 603.

One end portion of the flexible substrate 610 is fixed to a guide barrel flexible substrate fixing portion 610a provided in the guide barrel 6, and the other end portion of the flexible substrate 610 is fixed to a rear group lens barrel flexible substrate fixing portion 610b provided in the rear group lens barrel 603. Between the guide barrel flexible substrate fixing portion 610a and the rear group lens barrel flexible substrate fixing portion 610b, a position absorption portion 610c having a protruding curved shape (a U-turn shape) that absorbs a change in a relative position between the guide barrel 6 and the rear group lens barrel 603 in the optical axis direction is formed. In the present exemplary embodiment, a zoom operation from the wide state to the tele state moves the position absorption portion 610c to the side of the mount 4 relative to the rear group lens barrel 603. Similarly to the flexible substrate 610, the flexible substrate 611 is also fixed and held to be movable while bending in a protruding curved shape (a U-turn shape).

Next, the movement of the whole of the rear group unit 700 in the optical axis direction is described. In the third group unit 300, the third group cam follower 304 held by the third group lens barrel 302 is engaged with one of the cam grooves having a trajectory different from those of the rear group cam followers 604, and thus, the trajectory of the third group unit 300 is different from the trajectory of the rear group lens barrel 603 in the zoom operation. Specifically, the amounts of movement of the fourth group unit 400, the fifth group unit 500, and the sixth group unit 600 are greater than the amount of movement of the third group unit 300. Thus, in this configuration, the relative distances between the lenses of the third group unit 300 and the fourth group unit 400 become narrower by driving the rear group unit 700 from the wide state to the tele state.

FIGS. 17A and 17B illustrate the moving ranges of the diaphragm flexible substrate 314 and the flexible substrate 610. The upper diagram in FIG. 17A illustrates the wide state of the rear group unit 700 according to the present exemplary embodiment, and the lower diagram in FIG. 17A illustrates the tele state of the rear group unit 700 according to the present exemplary embodiment. The protruding curved shapes of the diaphragm flexible substrate 314 and the flexible substrate 610 are disposed facing each other.

A line W3 indicates a position of the position absorption portion 314c moved furthest to the image side (the mount side) in the wide state. A line W6 indicates a position of the position absorption portion 610c moved furthest to the object side in the wide state. In the wide state, the diaphragm flexible substrate 314 and the diaphragm flexible substrate holding member 313 are moved further to the object side with respect to the line W6 and set at positions where the diaphragm flexible substrate 314 and the diaphragm flexible substrate holding member 313 do not come into contact with the flexible substrate 610.

A line T3 indicates a position of the position absorption portion 314c moved furthest to the image side (the mount side) in the tele state. In the zoom operation, the position absorption portion 314c moves relative to the rear group lens barrel 603 within a diaphragm flexible substrate position absorption portion moving range 314R between the lines W3 and T3.

A line T6 indicates a position of the position absorption portion 610c moved furthest to the image side (the mount side) in the tele state. In the zoom operation, the position absorption portion 610c moves relative to the rear group lens barrel 603 within a flexible substrate position absorption portion moving range 610R between the lines W6 and T6.

The diaphragm flexible substrate position absorption portion moving range 314R and the flexible substrate position absorption portion moving range 610R overlap each other in the optical axis direction. In the tele state, the position absorption portions 314c and 610c enter a section of the position absorption portion 610c, which is the effective use of a space in a thrust direction.

FIG. 17B is a cross-sectional view of the diaphragm flexible substrate 314 and the flexible substrate 610 when viewed along the optical axis direction. When viewed in the optical axis direction, the diaphragm flexible substrate 314, the diaphragm flexible substrate holding member 313, and the flexible substrate 610 are disposed at positions where the diaphragm flexible substrate 314, the diaphragm flexible substrate holding member 313, and the flexible substrate 610 partly overlap each other in the radial direction and the rotational direction. As described above, the two position absorption portions 314c and 610c are disposed overlapping each other also in the radial direction and the rotational direction, which improves the effective use of an exclusive space of a flexible substrate (a flexible printed circuit (FPC)) in the rotational direction.

The third group unit 300 moves by a moving distance L3 in the optical axis direction relative to the guide barrel 6 fixed in the wide state and the tele state as illustrated in FIG. 2. The distance in the optical axis direction between the third group unit 300 and the sixth group unit 600 in the wide state is a distance W36. In a state of the distance W36, the third group unit 300 and the sixth group unit 600 are furthest away from each other. The distance in the optical axis direction between the third group unit 300 and the sixth group unit 600 in the tele state is a distance T36. In a state of the distance T36, the third group unit 300 and the sixth group unit 600 are closest to each other. If the amount of movement of the third group unit 300 relative to the sixth group unit 600 from the wide state to the tele state is L36, the relationships between the distances L3, W36, T36, and L36 are represented by the following formulas:
L36 = |W36 - T36| formula (A), and
L3 > L36 formula (B).

That is, the amount of movement in the optical axis direction of the third group unit 300 relative to the guide barrel 6 from the wide state to the tele state is greater than the amount of movement in the optical axis direction of the third group unit 300 relative to the fourth group unit 400 from the wide state to the tele state.

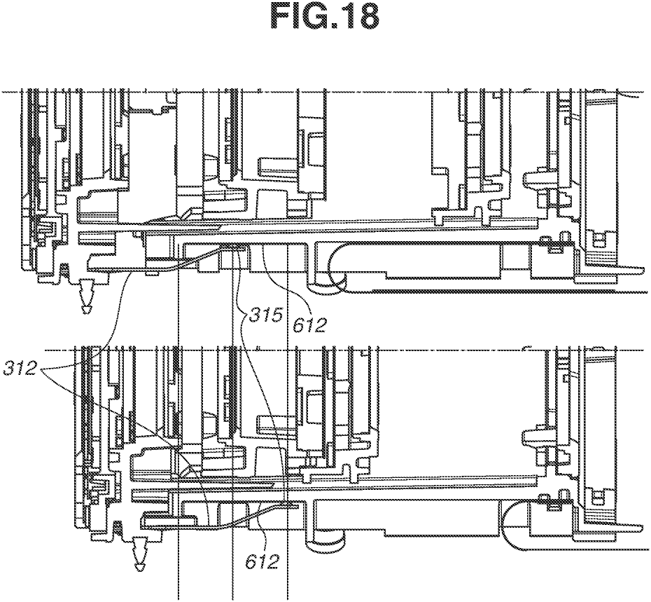

As illustrated in FIG. 18, in the rear group lens barrel 603, a sliding surface 612 on which a biasing point 315 biased by a leaf spring 312 slides is provided. That is, the third group unit 300 is biased in an approximately radial direction, and thus the third group unit 300 is biased toward the first guide shaft 605 and the second guide shaft 606. While the third group unit 300 is driven by the cam barrel 7 serving as a driving unit, the leaf spring 312 slides on the rear group lens barrel 603.

As described above, the amount of movement of the third group unit 300 relative to the sixth group unit 600 when a zoom operation is performed is smaller than the amount of movement of the third group unit 300 relative to the guide barrel 6 serving as a fixing member for the third group unit 300 actually moved by the cam barrel 7. That is, with the above-described configuration, even when the same zoom operation is repeated, a velocity of the sliding is small, and thus, abrasion is less likely to occur. Further, because the range of sliding is narrow, generation of abrasion powder is also reduced. Thus, it is possible to improve reliability of a case where the zoom operation is repeatedly performed, in comparison with a case where the sliding surface 612 is provided on the fixing member.

The sliding surface 612 is provided outside the rear group lens barrel 603, as a surface parallel to the optical axis. To the sliding surface 612, grease resistant to extreme pressure is applied to reduce abrasion. The sliding surface 612 is not linearly connected to an optical element in a space since the sliding surface 612 is provided on the outer circumference side. Thus, even when grease spatters or abrasion powder scatters by an impact, the grease or the abrasion powder is less likely to adhere to an optical element. If the grease or the abrasion powder adheres to a lens serving as an optical element, image quality may be affected. If the grease or the abrasion powder adheres to the blades of a diaphragm serving as an optical element, the diaphragm may fail to operate. Thus, the sliding surface 612 is provided outside, whereby reliability of resistance to impacts can be improved.

As described above, the third group unit 300 is guided straight by the sixth group unit 600, and the leaf spring 312 is biased between the third group unit 300 and the sixth group unit 600. Thus, even in the state where the leaf spring 312 is biased, the third group unit 300 does not rotate relative to the sixth group unit 600. Accordingly, when the third group unit 300 is assembled to the guide barrel 6 and the cam barrel 7, the third group unit 300 can be inserted as it is, whereby it is easy to assemble the third group unit 300.

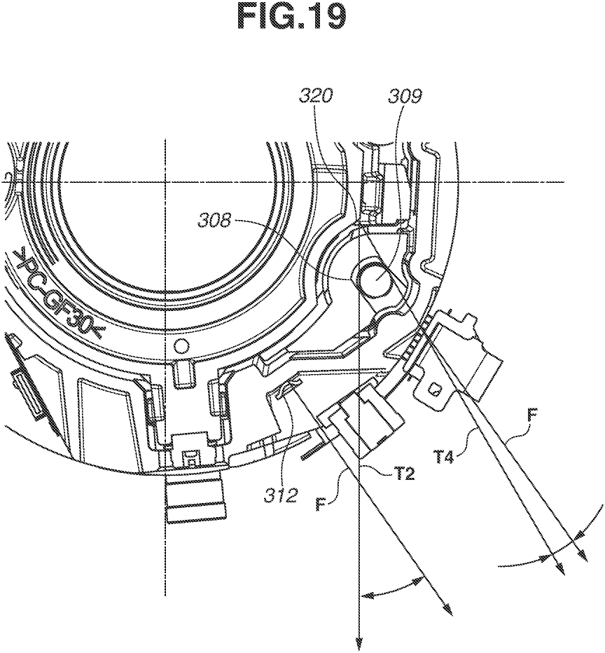

FIG. 19 is a cross-sectional view illustrating the angles between the direction of the biasing force of the leaf spring 312 and a second abutment surface 308 and a third abutment surface 309. A vector representing the direction of the biasing force is a biasing force vector F, and vectors of the second abutment surface 308 and the third abutment surface 309 obtained by extending straight lines from the second abutment surface 308 and the third abutment surface 309 when viewed from the optical axis are a second vector T2 and a third vector T4, respectively. The angle between the biasing force vector F and the second vector T2 is smaller than 90 degrees. That is, the biasing force acts in a direction in which the second abutment surface 308 is brought close to a first intersection point 320 while being biased by the leaf spring 312. The angle between the biasing force vector F and the third vector T4 is also smaller than 90 degrees, and similar effects are obtained. In this state, the smaller the angle between the second abutment surface 308 and the third abutment surface 309 is, the range where the biasing force vector F can satisfy conditions for the second vector T2 and the third vector T4 becomes wider. Thus, it is desirable that the angle between the second abutment surface 308 and the third abutment surface 309 is smaller than 60 degrees. In the present exemplary embodiment, the angle between the second abutment surface 308 and the third abutment surface 309 is set to 30 degrees.

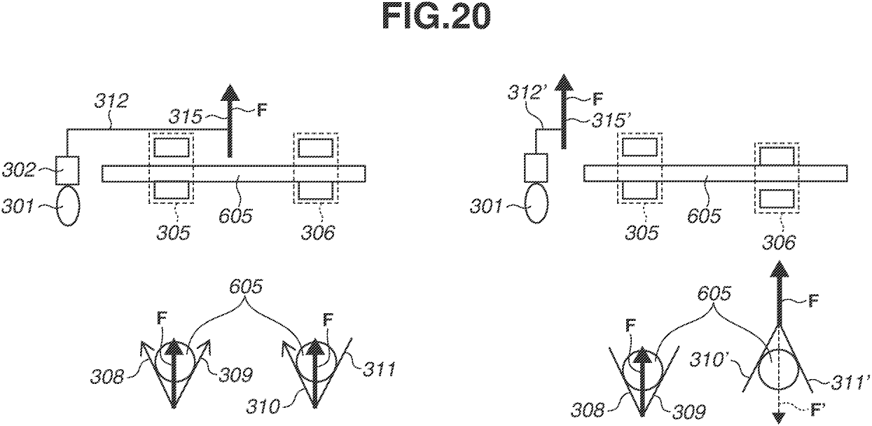

FIG. 20 is schematic diagrams illustrating the relationships between the biasing point 315 and the forces applied to the first engagement portion 305 and the second engagement portion 306. The left diagram in FIG. 20 is a schematic diagram illustrating the state where the biasing point 315 of the leaf spring 312 is between the first engagement portion 305 and the second engagement portion 306 as in the present exemplary embodiment. The right diagram in FIG. 20 is a schematic diagram illustrating the state where a biasing point 315′ of the leaf spring 312′ is outside the first engagement portion 305 and the second engagement portion 306. At each biasing point, the biasing force is applied upward.

When the biasing point 315 is between the first engagement portion 305 and the second engagement portion 306, the biasing force vector F is applied upward, whereby surfaces on the lower side of the first engagement portion 305 and the second engagement portion 306 abut the first guide shaft 605. That is, it is possible to form the second abutment surface 308 and a fourth abutment surface 310 in approximately the same shapes and cause them to abut on the first guide shaft 605, and also form the third abutment surface 309 and a fifth abutment surface 311 in approximately the same shapes and cause them to abut on the first guide shaft 605. Thus, the relationship between each of the fourth abutment surface 310 and the fifth abutment surface 311 and the biasing force vector F only needs to satisfy the same condition as the relationship between the second abutment surface 308 and the biasing force vector F.

On the other hand, when the biasing point 315′ is outside the first engagement portion 305 and the second engagement portion 306, the biasing force vector F is applied upward, whereby the surface on the lower side of the first engagement portion 305 abuts the first guide shaft 605. However, in the second engagement portion 306, because the biasing force is transmitted by rotating about the first engagement portion 305, a downward force F′ that is opposite to the biasing force vector F is applied to the second engagement portion 306, and consequently, a surface on the upper side of the second engagement portion 306 abuts the first guide shaft 605. That is, the angle between each of a fourth abutment surface 310′ and a fifth abutment surface 311′ and the biasing force vector F is set greater than 90 degrees, whereby it is possible to cause the first guide shaft 605 to abut the fourth abutment surface 310′ and the fifth abutment surface 311′.

In the present exemplary embodiment, components that account for a large portion of the weight of the third group unit 300, such as the third group lenses 301, are fixed further on the object side with respect to the first engagement portion 305. That is, the center of gravity of the third group unit 300 is outside the first engagement portion 305 and the second engagement portion 306. If the biasing force illustrated in FIG. 20 is considered as a weight applied to the center of gravity of the third group unit 300, the influence of gravity applied to the first engagement portion 305 of the third group unit 300 and the influence of gravity applied to the second engagement portion 306 of the third group unit 300 are different from each other.

Accordingly, the directions of forces based on the resultant vector of the biasing force and gravity in the first engagement portion 305 and the resultant vector of the biasing force and gravity in the second engagement portion 306 are different from each other. Thus, the shapes of the first engagement portion 305 and the second engagement portion 306 when viewed in the optical axis direction are differentiated, whereby it is possible to set abutment surfaces more advantageously.

According to the present disclosure, a restriction end for preventing a collision between members holding lenses is provided in a small space, whereby it is possible to miniaturize a lens device. While desirable exemplary embodiments of the present disclosure have been described above, the present disclosure is not limited to these exemplary embodiments, and these exemplary embodiments can be modified and changed in various ways within the scope of the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2021-167601, filed Oct. 12, 2021, which is hereby incorporated by reference herein in its entirety.

What is claimed is:

1. A lens device comprising:
a first moving member configured to hold an optical element and move in an optical axis direction;
a first shaft member configured to engage with a first guide portion of the first moving member and configured to guide a movement of the first moving member in the optical axis direction;
a base member configured to hold one end portion of the first shaft member; and
a holding member configured to hold the other end portion of the first shaft member,
wherein the base member is provided with an object side restriction end and an image side restriction end, the object side restriction end being configured to restrict the movement of the first moving member in a direction toward an object side, the image side restriction end being configured to restrict the movement of the first moving member in a direction toward an image side.

2. The lens device according to claim 1,
wherein the first guide portion is provided with a moving portion abutment portion configured to abut the object side restriction end and the image side restriction end, and
wherein, in a state where the first shaft member is fixed by the base member and the holding member, at least one of the object side restriction end and the image side restriction end partly overlap the moving portion abutment portion when viewed in the optical axis direction.

3. The lens device according to claim 2, further comprising:
a straight movement barrel including at least three straight movement grooves;
a cam ring held to be rotatable relative to the straight movement barrel and including at least three cam grooves; and
at least three cam followers configured to engage with the straight movement grooves and the cam grooves and fixed to the base member,
wherein the object side restriction end, the image side restriction end, and the moving portion abutment portion are disposed in respective phase areas between the cam followers when viewed in the optical axis direction.

4. The lens device according to claim 1, further comprising:
a second moving member configured to hold an optical element,
wherein the first shaft member engages with a second guide portion of the second moving member, and
wherein the second guide portion is disposed between the object side restriction end and the holding member.

5. The lens device according to claim 4, further comprising:
a second shaft member configured to engage with a first straight movement guide portion of the first moving member and a second straight movement guide portion of the second moving member and guide a movement of the first moving member and a movement of the second moving member in the optical axis direction,
wherein the first shaft member and second shaft member restrict rotation of the first moving member and a rotation of the second moving member in a plane orthogonal to an optical axis.

6. The lens device according to claim 4,
wherein an object side movement restriction end of the second moving member is disposed in the holding member, and
wherein an image side movement restriction end of the second moving member is disposed in the base member.

7. The lens device according to claim 5,
wherein the base member includes a first rotation restriction portion and a second rotation restriction portion configured to restrict, in a case where the first moving member rotates about any axis parallel to the optical axis inside the base member, the rotation of the first moving member,
wherein between the object side restriction end and the image side restriction end, the base member includes an insertion restriction end that is configured to come into contact with the first moving member when the first moving member is inserted into the base member,
wherein in a state where the second shaft member engages with the first straight movement guide portion and held by the base member and the holding member, the first moving member comes into contact with the first rotation restriction portion in a range between the object side restriction end and the insertion restriction end, and the first moving member comes into contact with the second rotation restriction portion in a range between the insertion restriction end and the image side restriction end, and
wherein in a state where the first shaft member engages with the first moving member and is held by the base member and the holding member, the first moving member does not come into contact with the first rotation restriction portion and second rotation restriction portion.

8. The lens device according to claim 1,
wherein in a range between the object side restriction end and the image side restriction end, the base member includes an insertion restriction end that is configured to come into contact with the first moving member when the first moving member is inserted into the base member, and
wherein a rotatable amount of the first moving member in a case where the first moving member rotates about any axis parallel to an optical axis between the object side restriction end and the insertion restriction end is greater than a rotatable amount of the first moving member in a case where the first moving member rotates about any axis parallel to the optical axis between the image side restriction end and the insertion restriction end.

9. An imaging apparatus comprising:
a lens device; and
an image sensor configured to receive light from the lens device,
wherein the lens device includes
a first moving member configured to hold an optical element and move in an optical axis direction;
a first shaft member configured to engage with a first guide portion of the first moving member and guide a movement of the first moving member in the optical axis direction;
a base member configured to hold one end portion of the first shaft member; and
a holding member configured to hold the other end portion of the first shaft member,
wherein the base member is provided with an object side restriction end and an image side restriction end, the object side restriction end being configured to restrict the movement of the first moving member in a direction toward an object side, the image side restriction end being configured to restrict the movement of the first moving member in a direction toward an image side.
